(19) United States
(12) Patent Application Publication
(10) Pub. No.: US 2002/0175626 A1
(43) Pub. Date: Nov. 28, 2002

(54) Cathode ray tube, scanning control device, and scanning method

(76) Inventor: Ryo Saito, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/145,109

(22) Filed: May 15, 2002

(30) Foreign Application Priority Data
May 28, 2001 (JP) P2001-158403

(51) Int. Cl. H01J 29/96

(52) U.S. Cl. 315/3

(57) ABSTRACT

A frame synchronizer disposed in a multiple-gun type cathode ray tube relatively delays outputting an image signal for one of split screens with respect to an image signal for the other split region. Thereby, a relative difference in scanning time of electron beams which scans the split screens is generated so that the sum of beam currents applied to a phosphor in the same pixel position per unit time does not exceed a limit of intensity saturation of the phosphor. Therefore, in a scanning mode that field (frame) scanning is carried out on the split screens on the right and the left sides in a direction opposite to each other, a intensity drop resulting from intensity saturation of the phosphor can be avoided, and a proper image can be displayed.

### BACKGROUND OF THE INVENTION

1. Field of the Invention

The present invention relates to a cathode ray tube comprising a plurality of electron guns, and combining a plurality of split screens to form a single screen for displaying an image, a scanning control device therein, and a scanning method.

2. Description of the Related Art

Cathode ray tubes (CRTs) are widely used for televisions and various monitors. A color CRT comprises an electron gun, which emits electron beams each corresponding to each color of R (red), G (green) and B (blue). In the color CRT, a phosphor of each color disposed in a panel portion is irradiated with the electron beam corresponding to each color of R, G and B to emit light of each color. A deflection scan is carried out with the electron beam of each color by a deflection system, and thereby, in the CRT, a scanning display corresponding to the electron beam scan is formed on a tube surface.

Although a typical CRT comprises a single electron gun, in recent years, CRTs comprising a plurality of electron guns have been developed. In other words, color CRTs comprising a plurality (for example, two) of electron guns emitting three electron beams of R, G, and B have been developed. A CRT using a plurality of electron guns is called a “multiple-gun type CRT” or the like. Technologies relating to the multiple gun type CRT are disclosed in, for example, Japanese Examined Utility Model Publication No. sho 39-25641, Japanese Examined Patent Publication No. sho 42-4928, Japanese Unexamined Patent Publication No. sho 50-17167 and so on. In the multiple-gun type CRT, the depth thereof can be reduced, as well as the screen size thereof can be expanded, compared with a CRT using a single electron gun. Further, compared with the CRT using a single electron gun, higher intensity can be obtained.

In the multiple-gun type CRT, a screen region is split into a plurality of screen regions, and the plurality of split screen regions (hereinafter referred to as split screens) are combined with one another to form one screen. The number of electron guns disposed therein is equal to the number of split screens. Each of the split screens is scanned by an electron beam emitted from each of the electron guns corresponding to each of the split screens. There are two types of screen layout in the multiple-gun type CRT: a screen layout that an edge of a split screen are simply linearly combined with an edge of another split screen to form one screen, and a screen layout that adjacent split screens are partially overlapped to form one screen.

Referring to FIGS. 1A through 1D, examples of screen scanning modes in the multiple-gun type CRT are described below. In this case, for the sake of simplicity, two electron beams emitted from two electron guns disposed on the left and the right sides, respectively, scan two screen regions 101L and 101R disposed on the left and the right sides, respectively. A central portion of a screen is an overlap region 102 where split screens 101L and 101R on the left and right sides are overlapped each other. The overlap region 102 is redundantly scanned by the two electron beams on the left and the right sides. A region other than the overlap region 102 is scanned by either of the two electron beams.

In each of the scanning modes shown in FIGS. 1A through 1D, line scanning (main scanning) is carried out in a vertical direction, and field (or frame) scanning is carried out in a horizontal direction. The scanning modes shown in FIGS. 1A and 1B among them are examples that field scanning is carried out on the split screens 101L and 102R disposed on the left and the right sides, respectively, in a direction opposite to each other. On the other hand, in the scanning modes shown in FIGS. 1C and 1D, field scanning is carried out on the split screens 101L and 101R in the same direction as each other.

More specifically, in an example of the scanning mode shown in FIG. 1A, line scanning is carried out in a direction from top to bottom (in Y direction in the drawing). On the other hand, field scanning is carried out on the split screen 101L in a direction from left to right (in X direction) viewed from an image-display surface, whereas field scanning is carried out on the split screen 101R in a direction from right to left (in -X direction). Therefore, in the scanning mode shown in FIG. 1A, field scanning is carried out in a horizontal direction from the outside of the screen to the inside (the central portion of the screen) as a whole.

In an example of the scanning mode shown in FIG. 1B, field scanning is carried out on the split screens 101L and 101R in directions opposite to those in the example shown in FIG. 1A. In other words, field scanning is carried out on the split screen 101L in a direction from right to left (in -X direction) viewed from the image-display surface, whereas field scanning is carried out on the split screen 101R in a direction from left to right (in X direction). Therefore, in the example of the scanning mode shown in FIG. 1B, field scanning is carried out in a horizontal direction from the inside of the screen to the outside as a whole.

In an example of the scanning mode shown in FIG. 1C, field scanning is carried out on both of the split screens 101L and 101R in a direction from left to right (in x direction) viewed from the image-display surface. On the contrary, in an example of the scanning mode shown in FIG. 1D, field scanning is carried out on both of the split screens 101L and 101R in a direction from right to left (in -X direction) viewed from the image-display surface.

As described above, various scanning modes are applicable in the multiple-gun type CRT, however, the following problems may arise depending on scanning modes.

Firstly, a problem in the scanning modes shown in FIG. 1A and 1B is described below. Before describing the problem, with refer to FIGS. 2A and 2B, a relation between screen position and intensity is described. In this case, it is considered that a uniform white level is obtained across the entire screen. The intensity of a phosphor screen (screen) in the CRT mainly depends on an amount of the beam current of an electron beam entering into the phosphor screen. In the display layouts shown in FIGS. 1A and 1B, the intensity in the overlap region 102 is equal to the sum of the intensities 111L and 111R (refer to FIG. 2A) generated from two electron beams on the left and the right side, respectively. At this time, for example, when a sine-wave shaped intensity gradient is produced in each of the intensities 111L and 111R, the sum 112 of the intensities 111L and 111R can be equal to the intensity in a screen region other than the overlap region 102 in theory. In order to produce a sine-wave shaped intensity gradient, as shown in FIG. 2B, electron beam currents 113L and 113R on the left and the right sides are reduced in the overlap region 102 in a curve according to the intensity gradient.

In the scanning modes shown in FIGS. 1A and 1B, in the overlap region 102, a phosphor portion which is scanned at the same time by the two electron beams exists. For example, in the split screens 101R and 101L, when scanning starts at the same time, a central portion 103 of the screen (the center of the overlap region 102) is scanned at the same time. On the other hand, a phosphor has a property that as the electron beam current increases, the intensity increases proportionately, but if the electron beam current becomes too large, the intensity becomes saturated.

In the scanning modes shown in FIGS. 1A and 1B, the values of the electron beam currents 113L and 113R are set at an limit value of intensity saturation Ib1 or less so as not to saturate the intensity of the phosphor. In the example shown in FIG. 2B, a region 115 where a sum 114 of the two electron beams exceeds the limit value of intensity saturation Ib1 exists. However, unless a phosphor of the region 115 in the same pixel position is scanned by the two electron beams at the same time, the electron beam current applied per unit time is at the limit value Ib1 or less, so no intensity saturation occurs. However, when there is a phosphor portion scanned by the two electron beams at the same time, the electron beam current applied per unit time exceeds limit value Ib1. Thus, when there is a phosphor portion where intensity saturation occurs, as a result, the intensity originally required cannot be obtained in the region, that is, a so-called intensity drop occurs. At this time, a portion 112A where the intensity drop occurs (refer to FIG. 2A) is observed as a dark line in the screen display, which is not preferable.

Next, referring to FIGS. 3A through 4C, a problem in the scanning modes shown in FIGS. 1C and 1D is described below.

In the scanning modes in FIGS. 1C and 1D, there is a large difference in time when the overlap region 102 is scanned in the split screens 101L and 101R. For example, in an example of the scanning mode in FIG. 1C, after the overlap region 102 is scanned by the electron beam on the right side at the beginning of a field period, the overlap region 102 is scanned by the electron beam on the left side at the end of the field period.

The difference in scanning time is described below in more detail referring to FIGS. 4A through 4C. FIGS. 4A through 4C show simplified waveforms of a synchronous signal (V Sync.), an image signal for the split screen 101R on the right side, and an image signal for the split screen 101L on the left side during field scanning, respectively. In FIGS. 4A through 4C, it is assumed that an image is displayed in a HDTV (High Definition Television) system. The number of line scanning lines from either edge on the right or the left sides of the entire screen to the center 103 of the screen is 485.5 H per field, as shown in FIG. 5. Further, the number of line scanning lines from either edge on the right or the left sides of the overlap region 102 to the center 103 of the screen is 32 H. H indicates a scanning line for line scanning.

In the scanning mode in FIG. 1C, as shown in FIG. 4B, in the split screen 101R on the right side, scanning is carried out on the center 103 of the screen, that is, the center of the overlap region 102 at a time PR1 after a lapse of 32 H (for example, 0.95 ms) from the beginning of a scanning period in an odd field (ODD). On the other hand, in the split screen 101L on the left side, scanning is carried out on the center 103 of the screen at a time PL1 after a lapse of 453.5 H (for example, 13.4 ms) from the time PR1. After that, in the split screen 101R on the right side, scanning is carried out on the center 103 of the screen at a time PR2 after a lapse of 154 H (for example, 4.6 ms) from the time PL1 in the next field (EVEN).

As can be seen from above, with regard to the same pixel position in the overlap region 102, a time (PL1) when scanned by the electron beam on the left side is closer to a time (PR2) after a delay of 1 field (frame) than a time (PR1) when scanned by the electron beam on the right side in the same field (frame). In the case of the scanning mode in FIG. 1D, a time relation between scanning time on the right side and on the left side in the scanning mode in FIG. 1C is just reversed, so the same holds true for the scanning mode in FIG. 1D.

Thus, in the scanning modes in FIGS. 1C and 1D, there is a large difference in time when the same pixel position in the overlap region 102 is scanned in the split screens 101L and 101R on the left and the right sides, so the problem described above, that is, intensity saturation which occurs in the scanning modes in FIGS. 1A and 1B does not arise, although a problem that an expanded or contracted image such as character or picture is observed arises as described below.

As shown in FIG. 3A, the scanning mode in FIG. 1C is taken as an example here. Firstly, as shown in FIGS. 3B through 3D, a rectangular-shaped image 131 is moved (panned) from left to right (that is, in the same direction as the direction of field scanning) on the screen to be displayed. In the case where the image 131 is display in such a manner, when the image 131 goes across the overlap region 102 (refer to FIG. 3C), the image 131 originally designed to have a width X1 is observed in a state that the width of the image 131 is expanded to a width X2 (>X1). The above problem arises because scanning on the right side is carried out 1 field earlier than on the left side, and thereby, a temporally leading image is displayed on the screen on the right side earlier than on the screen on the left side. Conversely, as shown in FIGS. 3E through 3G, in the case where an rectangular-shaped image 132 is moved from right to left (that is, in a direction opposite to the direction of field scanning) on the screen, when the image 131 goes across the overlap region 102 (refer to FIG. 3F), the image 132 is observed in a state that the width of the image 132 is contracted to a width X3 (<X1).

As described above, in the multiple-gun type CRT, problems specific to the scanning modes may arise.

### SUMMARY OF THE INVENTION

In view of foregoing, it is an object of the present invention is to provide a cathode ray tube (CRT) capable of solving problems specific to scanning modes in a multiple-gun type CRT so as to display a proper image, a scanning control device therein, and a scanning method.

A cathode ray tube according to a first aspect of the invention comprises a plurality of electron guns emitting a plurality of electron beams for scanning the plurality of screen regions to the phosphor screen, and a frame synchronizer generating a relative difference in scanning time of the plurality of electron beams scanning the plurality of screen regions so that the sum of beam currents applied to a phosphor in the same pixel position per unit time does not exceed a limit of intensity saturation of the phosphor in a region where the plurality of screen regions overlap one another.

A scanning control device in a cathode ray tube and a scanning method according to the first aspect of the invention comprises a frame synchronizer generating a relative difference in scanning time of the plurality of electron beams scanning the plurality of screen regions so that the sum of beam currents applied to a phosphor in the same pixel position per unit time does not exceed a limit of intensity saturation of the phosphor in a region where the plurality of screen regions overlap one another.

In a cathode ray tube, a scanning control device therein and a scanning method according to the first aspect of the invention, a relative difference in scanning time of the plurality of the electron beams scanning the plurality of screen regions is generated, and thereby screen scanning is carried out so that the sum of beam currents applied to a phosphor in the same pixel position per unit time does not exceed a limit of intensity saturation of the phosphor in a region where the plurality of screen regions overlap one another.

A cathode ray tube according to a second aspect of the invention comprises a plurality of electron guns emitting a plurality of electron beams for scanning the plurality of screen regions based on a plurality of image signals applied, a memory means storing a plurality of frames of image data for one of two adjacent screen regions, and a generation means carrying out image interpolation processing based on the image data stored in the memory means so as to apply an image signal in a state that the content of a image is temporally shifted between two adjacent screen regions to the electron guns, and thereby generating a new image signal delayed behind an image signal for the other screen region only by a predetermined period and outputting the generated image signal as the image signal for the one of the screen regions.

A scanning control device in a cathode ray tube and a scanning method according to the second aspect of the invention comprises a memory means storing a plurality of frames of image data for one of two adjacent screen regions, and a generation means carrying out image interpolation processing based on the image data stored in the memory means so as to apply an image signal in a state that the content of a image is temporally shifted between the two adjacent screen regions to the electron guns, and thereby generating a new image signal delayed behind an image signal for the other screen region only by a predetermined period and outputting the generated image signal as the image signal for the one of the screen regions.

In a cathode ray tube, a scanning control device therein and a scanning method according to the second aspect of the invention, image interpolation processing is carried out to generate a new image signal delayed behind an image signal for the other screen region only by a predetermined period, and then the generated image signal is outputted as the image signal for the one of the screen regions. An image signal in a state that the content of an image is temporally shifted between two adjacent screen regions is applied to the electron guns.

Other and further objects, features and advantages of the invention will appear more fully from the following description.

### BRIEF DESCRIPTION OF THE DRAWINGS

FIGS. 1A through 1D are illustrations for explaining scanning modes of electron beams in a multiple-gun type CRT.

FIGS. 2A is a characteristic diagram for explaining a relation between screen position and intensity, and FIG. 2B is a characteristic diagram for explaining a relation between screen position and electron beam current.

FIGS. 3A through 3G are illustrations for explaining a phenomenon that an image generated in a scanning mode shown in FIG. 1C is expanded and contracted.

FIGS. 4A through 4C are waveform charts for explaining a difference in scanning time on the right side and on the left side in the scanning mode shown in FIG. 1C.

FIG. 5 is an illustration for explaining an example of a screen layout in the scanning mode shown in FIG. 1C.

FIG. 6B is a front view of a screen layout of a CRT according to a first embodiment of the invention, and FIG. 6A is a cross-sectional view taken along the line IA-IA in FIG. 6B.

FIGS. 7A and 7B are illustrations for explaining scanning modes of electron beams applied to the CRT according to the first embodiment and screen layouts.

FIG. 8 is a block diagram showing an example of a configuration of signal processing circuits in the CRT according to the first embodiment.

FIGS. 9A through 9E are waveform charts of various signals in the CRT according to the first embodiment.

FIG. 10A is a characteristic diagram for explaining a relation between screen position and intensity, and FIG. 10B is a characteristic diagram for explaining screen position and electron beam current.

FIGS. 11A and 11B are characteristic diagrams showing a relation between scanning time and beam current in the case where each split screen is scanned with an image signal with a delay.

FIGS. 12A and 12B are illustrations for explaining scanning modes of electron beams applied to a CRT according to a second embodiment and screen layouts.

FIG. 13 is a block diagram showing an example of a configuration of signal processing circuits in the CRT according to the second embodiment.

FIGS. 14A and 14B are block diagrams showing specific configurations of frame memories in an image interpolation portion of the CRT according to the second embodiment.

FIGS. 15A through 15K are illustrations for explaining an interpolation image generated by the image interpolation portion of the CRT according to the second embodiment and schematic composite images using an interpolated image.

### DETAILED DESCRIPTION OF THE PREFERRED EMBODIMENTS

Preferred embodiments of the present invention are described in more detail below referring to the accompanying drawings.

### First Embodiment

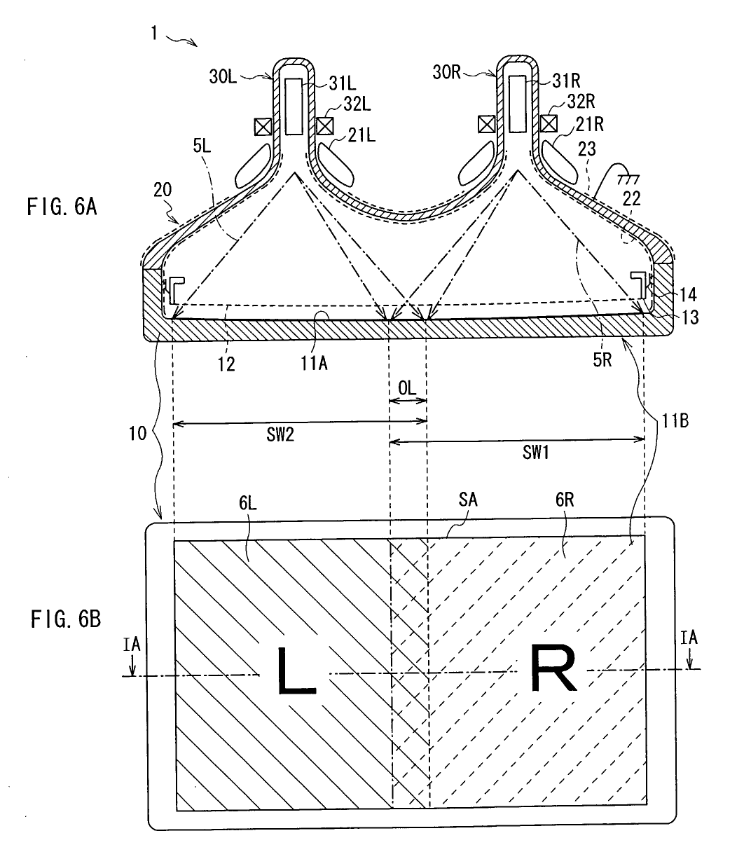

As shown in FIGS. 6A and 6B, a cathode ray tube (CRT) 1 according to a first embodiment comprises a panel portion 10 in which a phosphor screen 11A is formed, and a funnel portion 20 integrally combined with the panel portion 10. Two neck portion 30L and 30R including electron guns 31L and 31R, respectively, are formed on the left and the right sides of a rear end portion of the funnel portion 20, respectively. The CRT 1 is configured of the panel portion 10, the funnel portion 20 and neck portions 30L and 30R so as to form a two-funnel-shaped appearance as a whole. The whole appearance which forms the CRT 1 is also called an “envelope”. In the panel portion 10 and the funnel portion 20, aperture portions of the panel portion 10 and the funnel portion 20 are fused together with each other, so that a high vacuum state can be maintained in the interior thereof. On the phosphor screen 11A, a phosphor pattern which emits light according to incidence of beams 5L and 5R is formed. A surface of the panel portion 10 is an image display surface (tube surface) 11B where an image is displayed by light emission of the phosphor screen 11A.

In the CRT 1, a color selection mechanism 12 made of a thin metal plate facing the phosphor screen 11A is disposed. An outer portion of the color selection mechanism 12 is supported by a frame 13, and the color selection mechanism 12 is mounted on the inner surface of the panel portion 10 with a support spring 14 disposed on the frame 13.

On the funnel portion 20, an anode terminal (anode button) (not shown) for applying an anode voltage HV is disposed. Deflection yokes 21L and 21R and convergence yokes 32L and 32R are disposed on an outer portion from the funnel portion 20 to each of the neck portions 30L and 30R. The deflection yokes 21L and 21R are provided to deflect electron beams 5L and 5R emitted from the electron guns 31L and 31R, respectively. The convergence yokes 32L and 32R are provided to carry out convergence of electron beams for each color emitted from the electron guns 31L and 31R.

An inner surface from the neck portion 30 to the phosphor screen 11A of the panel portion 10 is coated with an internal conductive film 22. The internal conductive film 22 is electrically connected with the anode terminal, so an anode voltage (high voltage) HV is applied to the internal conductive film 22 via the anode terminal. Also, an outer surface of the funnel portion 20 is coated with an external conductive film 23.

Each of the electron guns 31L and 31R includes three cathodes (thermal cathodes) corresponding to colors of R, G and B, respectively, a heater for heating the cathodes and a plurality of grids disposed in front of the cathodes all of which are not shown in the drawing. The electron beams 5L and 5R emitted from the electron guns 31L and 31R pass through the color selection mechanism 12 and so on, and then are emitted to phosphors corresponding to colors in the phosphor screen 11A.

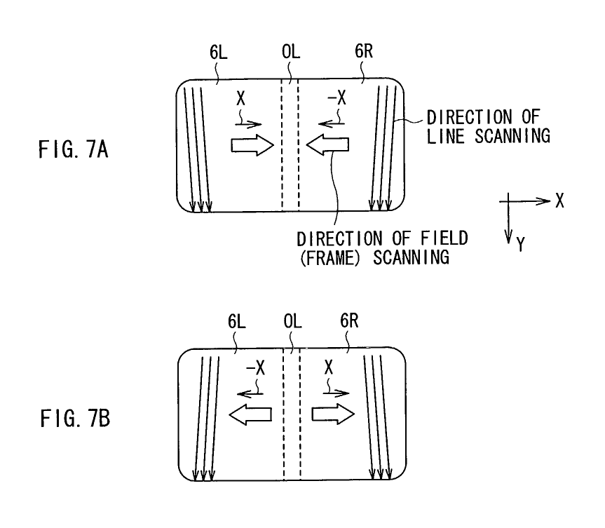

Referring to FIGS. 6B, 7A and 7B, the screen layout of the CRT 1 and a scanning mode of the electron beams are schematically described below. In the CRT 1, a substantially left half of the screen is drawn by the electron beam 5L emitted from the electron gun 31L disposed on the left side, and a substantially right half of the screen is drawn by the electron beam 5R emitted from the electron gun 31R disposed on the right side. Then, an edge portion of each of the split screens 6L and 6R formed by the electron beams 5L and 5R overlap each other to combine together, so that a single screen SA as a whole is formed to display an image. Therefore, a central portion of the screen SA formed by the combination of the split screens 6L and 6R is an overlap region OL where the split screens 6L and 6R overlap each other. A portion of the phosphor screen 11A in the overlap region OL is shared with (scanned by) the electron beams 5L and 5R.

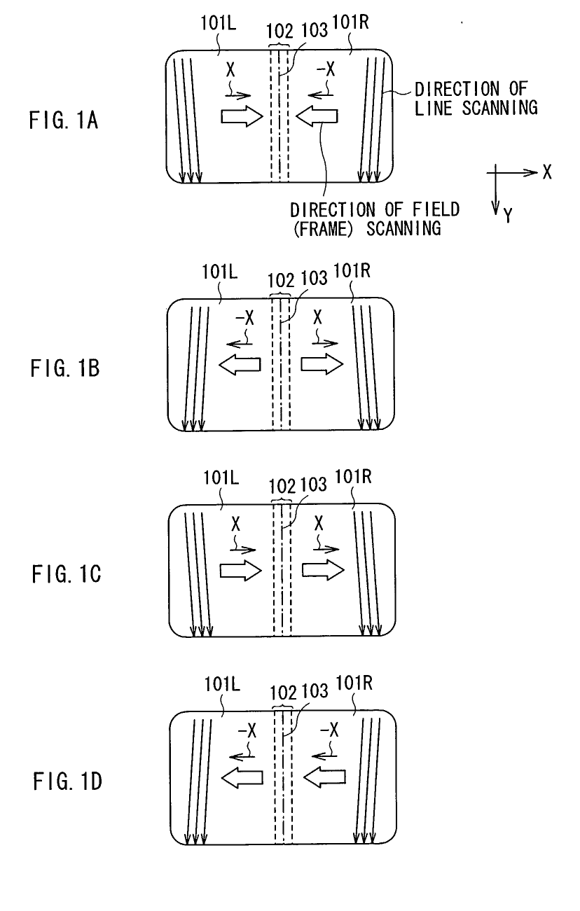

In the embodiment, scanning modes shown in FIGS. 7A and 7B are applied. In the scanning mode shown in FIG. 7A, like an example of the scanning mode shown in FIG. 1A, line scanning by each of the electron beams 5L and 5R is carried out in a direction from the top of the screen to the bottom thereof (in Y direction in the drawing). On the other hand, field (or frame) scanning is carried out on the split screen 6L on the let side in a direction from left to right viewed from an image-display surface (in X direction), whereas field scanning is carried out on the split screen 6R in a direction from right to left viewed from the image-display surface (in -X direction).

Moreover, in the scanning mode shown in FIG. 7B, like an example of the scanning mode shown in FIG. 1B, the direction of field scanning is opposite to the direction in the example shown in FIG. 7A. In other words, field scanning is carried out by the electron beam 5L on the left side in a direction from right to left viewed from the image-display surface (in -X direction), whereas field scanning is carried out by the electron beam 5R on the right side in a direction from left to right viewed from the image-display surface (in X direction).

Thus, in the embodiment, the scanning modes that field scanning is carried out on the split screens 6L and 6R in a direction opposite to each other are applied. Further, line scanning can be carried out in a direction from the bottom of the screen to the top thereof.

In the embodiment, an over-scanning region is adjusted by the deflection yokes 21L and 21R. The over-scanning region is a region outside of each of the scanning regions of the electron beams 5L and 5R, each of which forms an effective region in each of the scanning regions of the electron beams 5L and 5R. Further, in FIGS. 6A and 6B, a region SW1 is an effective region in a direction horizontal to the electron beam 5R, and a region SW2 is an effective region in a direction horizontal to the electron beam 5L.

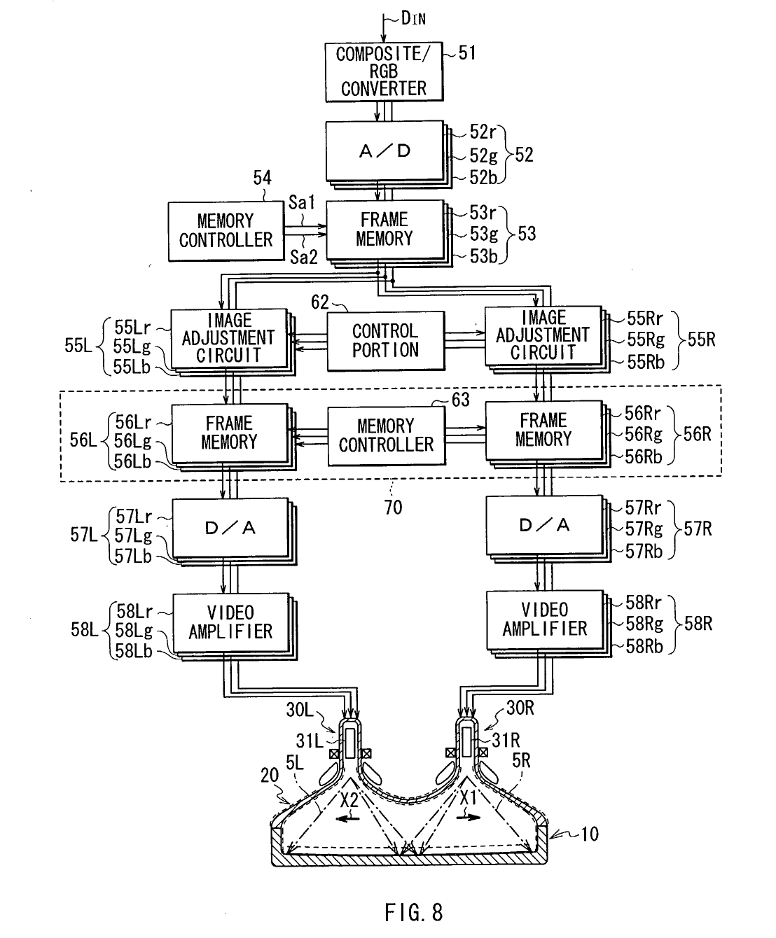

FIG. 8 shows an example of circuits for displaying a moving image corresponding to an analog composite signal of, for example, an NTSC (National Television System Committee) system or a HDTV system in the CRT 1 by one-dimensionally inputting the signal as an input signal (image signal) D_{IN}.

As shown in FIG. 8, the CRT 1 comprises a composite/RGB converter 51, an analog/digital signal (hereinafter referred to as “A/D”) converter 52 (52r, 52g and 52b), a frame memory 53 (53r, 53g and 53b) and a memory controller 54.

The composite/RGB converter 51 converts an analog composite signal as an input signal into a signal for each color of R, G and B. The A/D converters 52r, 52g and 52b convert the analog signal for each color of R, G and B outputted from the composite/RGB converter 51 into a digital signal. The frame memories 53r, 53g and 53b two-dimensionally store the digital image signal outputted from the A/D converter 52 by color of R, G and B in frame. As the frame memory 53, for example, an SDRAM (Synchronous Dynamic Random Access Memory) or the like is used. The memory controller 54 creates a write address and a read address of the image signal for the frame memory 53 to control a write operation and a read operation of the image signal for the frame memory 53. The memory controller 54 reads out an image signal for an image drawn by the electron beam 5L on the left side (for the split screen 6L on the left side) and an image signal for an image drawn by the electron beam 5R on the right side (for the split screen 6R on the right side) from the frame memory 53 by color to dividedly output the image signals.

The CRT 1 further comprises image adjustment circuits 55L (55Lr, 55Lg and 55Lb) and 55R (55Rr, 55Rg and 55Rb) for carrying out various image processing and signal processing on the image signals for the split screens 6L and 6R dividedly outputted from the frame memory 53, and a control portion 62 for controlling the image adjustment circuits 55L and 55R. Each of the image adjustment circuits 55L and 55R includes, for example, a DSP (Digital Signal Processor) circuit. The control portion 62 includes, for example, a microcomputer. These circuits are provided to correct a raster distortion and the intensity in the overlap region OL, and to carry out image processing, etc. corresponding to each of the scanning modes shown in FIGS. 7A and 7B. Circuit for carrying out these processing are described in more detail in Japanese Patent No. 3057230, etc. by the same applicant of the present invention. The scanning direction of the screen is determined by processing in the image adjustment circuits 55L and 55R.

The CRT 1 still further comprises a frame synchronizer 70 for synchronization between the split screens 6L and 6R. The frame synchronizer 70 includes frame memories 56L (56Lr, 56Lg and 56Lb) and 56R (56Rr, 56Rg and 56Rb) and a memory controller 63.

The frame memories 56Lr, 56Lg and 56Lb have a function of storing image signals for the split screen 6L on the left side outputted from the image adjustment circuit 55L by color of R, G and B in frame, respectively. Likewise, the frame memories 56Rr, 56Rg and 56Rb have a function of storing image signals for the split screen 6R on the right side outputted from the image adjustment circuit 55R by color of R, G and B in frame, respectively. The memory controller 63 has a function of controlling a write operation and a read operation of the image signals for the frame memories 56L and 56R. The memory controller 63 controls the output of the image signals from the frame memories 56L and 56R by generating a relative difference in time between the image signals for the split screens 6L and 6R so that a predetermined region in the overlap region OL is simultaneously scanned by the electron beams 5L and 5R (that is, no intensity saturation occurs in the phosphor).

Further, the CRT 1 comprises digital/analog signal (hereinafter referred to as “D/A”) converters 57L (57Lr, 57Lg and 57Lb) and 57R (57Rr, 57Rg and 57Rb) and video amplifiers 58L (58Lr, 58Lg and 58Lb) and 58R(58Rr, 58Rg and 58Rb).

Each of the D/A converters 57Lr, 57Lg and 57Lb has a function of converting the image signal for each color read out from the frame memory 56L into an analog signal, and outputting the analog signal. Each of the video amplifiers 58Lr, 58Lg and 58Lb has a function of amplifying the analog image signal outputted from the D/A converter 57L by color and applying the signal to the cathode corresponding to the electron gun 31L. The D/A converter 57R and the video amplifier 58R have functions of carrying out the same processing as of the D/A converter 57L and the video amplifier 58L, respectively, on the image signal for the split screen 6R on the right side.

Incidentally, in the embodiment, the frame memories 56L and 56R correspond to specific examples of “a first memory means” and “a second memory means”, respectively, in the invention. Further, in the circuits shown in FIG. 8, a circuit portion including at least the frame synchronizer 70 corresponds to a specific example of “a scanning control device” in the invention.

Next, operations of the CRT 1 having the above configuration are described below.

Firstly, a general operation of the CRT 1 is described below. The analog composite signal one-dimensionally inputted as an input signal (image signal D_{IN}) is converted into a signal for each color of R, G and B by the composite/RGB converter 51 (refer to FIG. 8), and the signal for each color of R, G and B is converted into a digital signal by the A/D converter 52. At this time, it is preferable to carry out an IP (Interlace to Progressive) conversion so that post-processing becomes easier. The digital image signal outputted from the A/D converter 52 is stored in the frame memory 53 by color in frame according to a control signal Sa1 indicating a write address generated in the memory controller 54.

The image signal in frame stored in the frame memory 53 is read out according to a control signal Sa2 indicating a read address generated in the memory controller 54, and the image signal is split into an image signal for the split screen 6L on the left side and an image signal for the split screen 6R on the right side to be outputted.

The image signals dividedly outputted are firstly inputted into the image adjustment circuits 55L and 55R. The image adjustment circuits 55L and 55R carry out a correction of raster distortion, a correction of intensity in the overlap region OL and image processing corresponding to each of the scanning modes shown in FIGS. 7A and 7B in response to the image signals on the left and the right sides, respectively. At this time, the scanning direction of the screen is determined.

Next, the image signals on the left and the right sides are inputted into the frame synchronizer 70 (the frame memories 56L and 56R thereof, respectively). The frame synchronizer 70 relatively delays outputting either of the image signals with respect to the other image signal, as described later. Then, the image signals on the left and the right sides outputted from the frame synchronizer 70 are converted into analog signals by the D/A converters 57L and 57R, respectively. The video amplifiers 58L and 58R amplify the image signals converted into analog signals by color and then apply the analog signals to the cathodes corresponding to the electron guns 31L and 31R as cathode drive voltages.

The electron guns 31L and 31R emit the electron beams 5L and 5R by color in accordance with the cathode drive voltages applied so as to correspond to the image signals. The electron beam 5L on the left side emitted from the electron gun 31L and electron beam 5R on the right side emitted from the electron gun 31R pass through the color selection mechanism 12, and are applied to the phosphor screen 11A. At this time, a beam current corresponding to the image signal for each color flows through each of the cathodes of the electron guns 31L and 31R from the high voltage side (the anode side) disposed on the side of panel portion 10. Moreover, at this time, the electron beam 5L and 5R converge by the electromagnetic interactions of the convergence yokes 32L and 32R, and are deflected by the electromagnetic interactions of the deflection yokes 21L and 21R. Thereby, the entire phosphor screen 11A is scanned by the electron beams 5L and 5R, and a desired image is displayed in the screen SA (refer to FIG. 6B) on the tube surface 11B of the panel portion 10. More specifically, a substantially left half of the screen is drawn by the electron beam 5L on the left side to form the split screen 6L, and a substantially right half of the screen is drawn by the electron beam 5R on the right side to form the split screen 6R. Edge portions of the split screens 6L and 6R formed in such a manner are combined together so as to overlap each other in the overlap region OL, so that a single screen SA is formed as a whole.

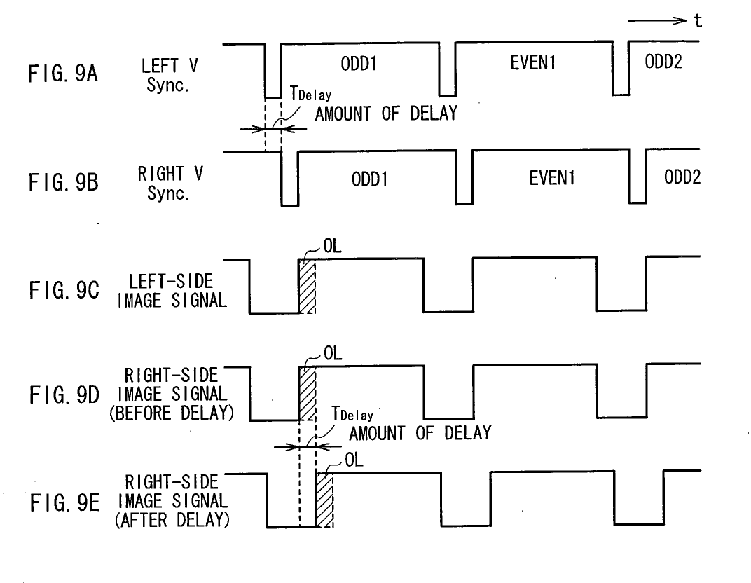

Next, referring to FIGS. 9A through 9E, a signal processing operation of the frame synchronizer 70, which is a major characteristic of the invention, is described below.

FIGS. 9A through 9E show signal waveforms in the case where an image is displayed in a HDTV system. Among them, FIGS. 9A and 9B show synchronous signals (V Sync.) in field scanning. FIG. 9A shows a synchronous signal for the split screen 6L on the left side, and FIG. 9B shows a synchronous signal for the split screen 6R on the right side. FIGS. 9C through 9E show image signals.

The image signals of, for example, the waveforms shown in FIGS. 9C and 9D are inputted into the frame memories 56L and 56R, respectively. When the scanning mode is the one shown in FIG. 7B, a signal portion corresponding to the overlap region OL is a hatched portion in FIGS. 9C and 9D. For example, as shown in FIG. 9E, the memory controller 63 controls the readout from the frame memories 56L and 56R so as to relatively delay outputting the image signal on the right side inputted into the frame memory 56R by a delay T_{Delay}, which is described later, with respect to the image signal on the left side inputted into the frame memory 56L. Conversely, the memory controller may delay outputting the image signal on the left side.

For example, as shown in FIGS. 9A and 9B, the memory controller 63 delays the synchronous signals on the left and the right sides, and outputs signals from the frame memories 56L and 56R in synchronization with the delayed synchronous signals so as to delay the image signals. Without delaying the synchronous signal, either of the image signals may be delayed by a predetermined period (the delay T_{Delay}) relative to the other image signal.

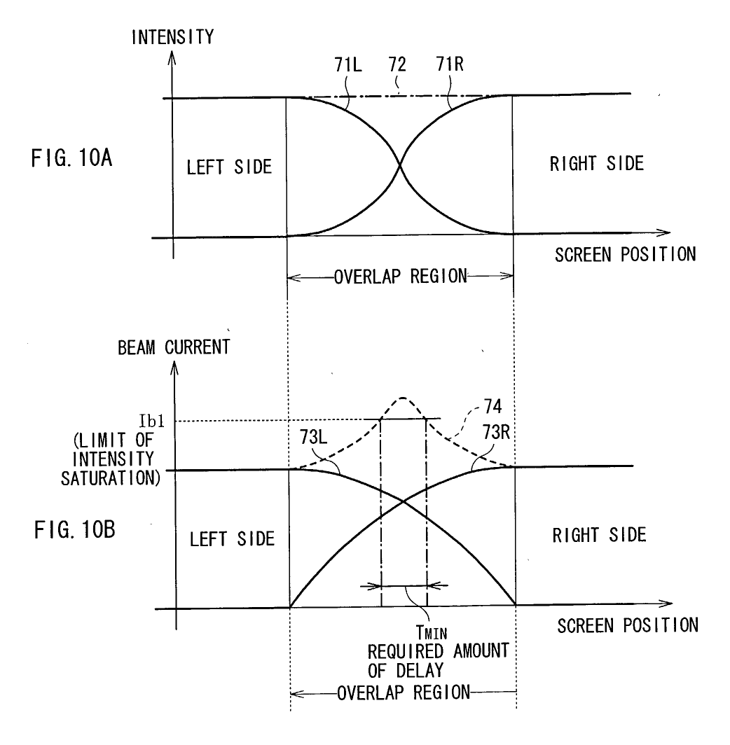

Next, referring to FIGS. 10A and 10B, the delay T_{Delay} is described below. The intensity in the overlap region OL is equal to the sum of the intensities 71L and 71R (refer to FIG. 10A) generated from the electron beams 5L and 5R on the left and the right sides, respectively. At this time, for example, when a sine-wave shaped intensity gradient is produced in each of the characteristics of the intensities 71L and 71R, a sum 72 of the intensities 71L and 71R can be equal to the intensity in a screen region other than the overlap region OL in theory. In order to produce a sine-wave shaped intensity gradient, as shown in FIG. 10B, electron beam currents 73L and 73R on the left and the right sides are reduced in the overlap region OL in a curve according to the intensity gradient.

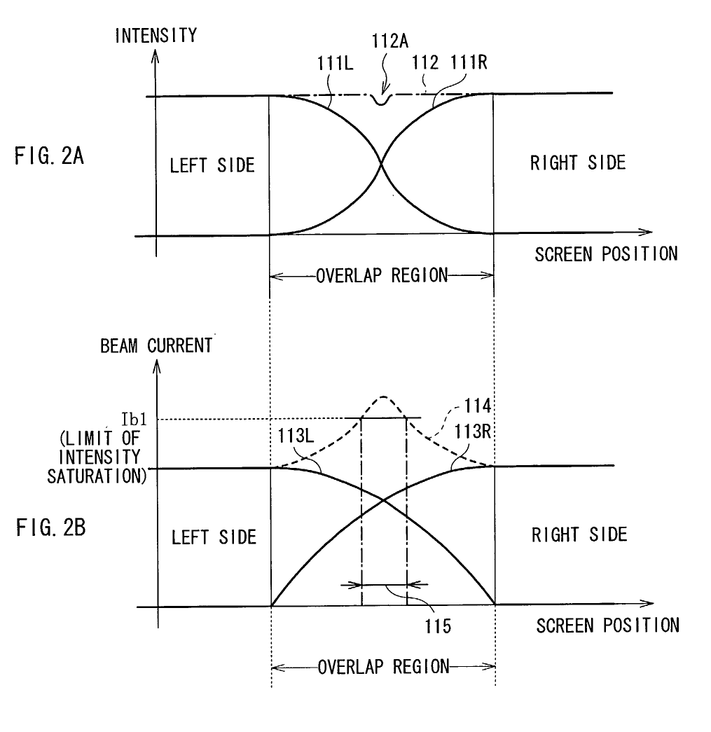

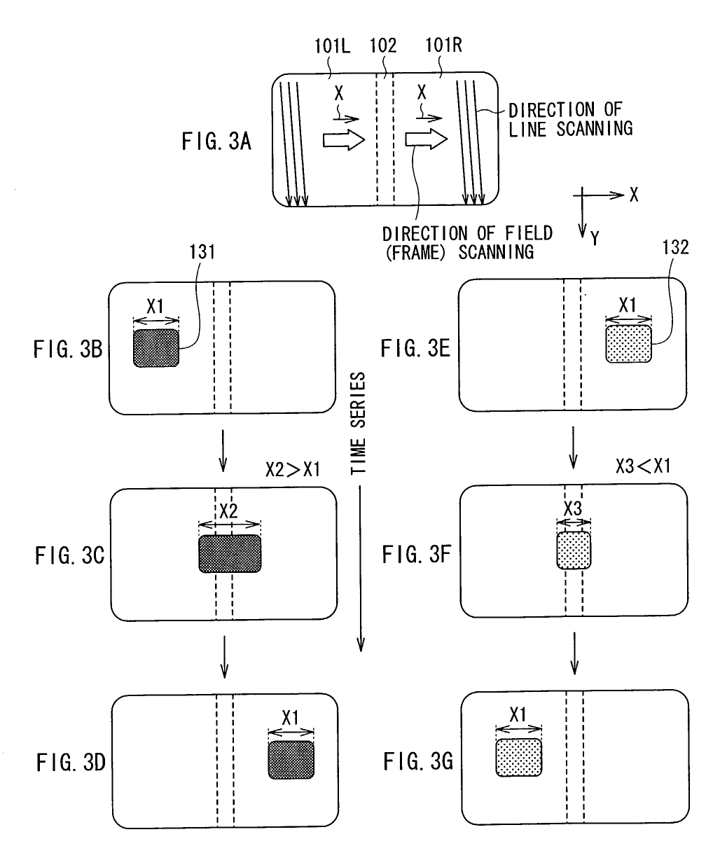

In the CRT 1, the two electron beam currents 73L and 73R are set at an limit value of intensity saturation Ib1 or less so as not to saturate the intensity of the phosphor. In the example shown in FIG. 10B, a region where a sum of currents 74 of the two electron beams 5L and 5R on the left and the right sides exceeds the limit value of intensity saturation Ib1 exists. However, unless a phosphor of the region in the same pixel position is scanned by the two electron beams 5L and 5R at the same time, the electron beam current applied per unit time is at the limit value Ib1 or less, so no intensity saturation occurs. Therefore, if a relative difference in time when the overlap region is scanned by the electron beams 5L and 5R with at least a period T_{MIN} corresponding to the region is given, no intensity saturation occurs. In other words, without generating a portion 112A (refer to FIG. 2A) where an intensity drop occurs, as shown in FIG. 10A, the sum 72 of the intensities by the electron beams 5L and 5R on the left and the right side can be equal to the intensity in the screen region other than the overlap region OL.

Accordingly, as the delay T_{Delay} of the image signal, at least the period T_{MIN} is required. In other words, the delay T_{Delay} is required by a signal period corresponding to a period when a region where the sum of beam currents applied to the phosphor of the overlap region OL in the same pixel position exceeds the intensity saturation limit of the phosphor is scanned. However, it is not preferable that the delay T_{Delay} is too long, because a large difference in time when the overlap region OL is scanned in the split screens arises, and consequently, the problem in the scanning modes shown in FIGS. 1C and 1D, that is, a problem that an expanded or contracted image is observed arises. It is considered that a sufficient amount of the delay T_{Delay} is substantially equal to a period of scanning the overlap region OL. In relation to the number of scanning lines, for example, when the scanning lines are in a state shown in FIG. 5, a delay by at least a period corresponding to 32 H is required, and more preferably, a delay by a period corresponding to 64 H is required.

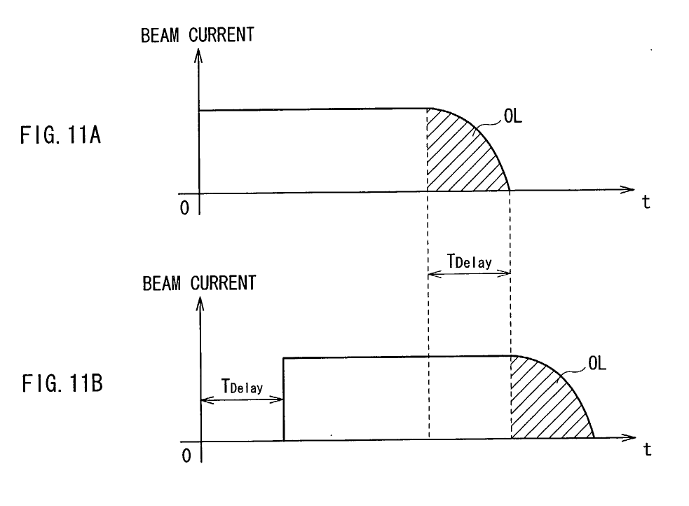

When the image signal is delayed as described above, and screen scanning is carried out, a relation between a scanning time t and the beam current is, for example, as shown in FIGS. 11A and 11B. FIGS. 11A and 11B correspond to the image signals shown in FIGS. 9C and 9E, respectively. As shown in FIGS. 11A and 11B, When the delay T_{Delay} is substantially equal to a period of scanning the overlap region OL, electron beam currents by the two electron beams 5L and 5R on the left and the right sides are not simultaneously applied to the phosphor of the overlap region OL in the same pixel position.

As described above, according to the embodiment, by relatively delaying outputting either of the image signals for the split screens 6L and 6R with respect to the other image signal, a relative difference in scanning time of the electron beams 5L and 5R which scan the split screens 6L and 6R, respectively, arises, so the sum of beam currents applied to the phosphor in the same pixel position per unit time is prevented from exceeding the limit of intensity saturation of the phosphor. Therefore, in the scanning mode that field (or frame) scanning is carried out on the split screens 6L and 6R on the left and the right sides in a direction opposite to each other, the intensity saturation of the phosphor in the overlap region OL is prevented. Thereby, the intensity drop due to the intensity saturation of the phosphor can be avoided, so a proper image can be displayed in the scanning modes shown in FIGS. 7A and 7B.

### Second Embodiment

Next, a second embodiment of the invention is described below.

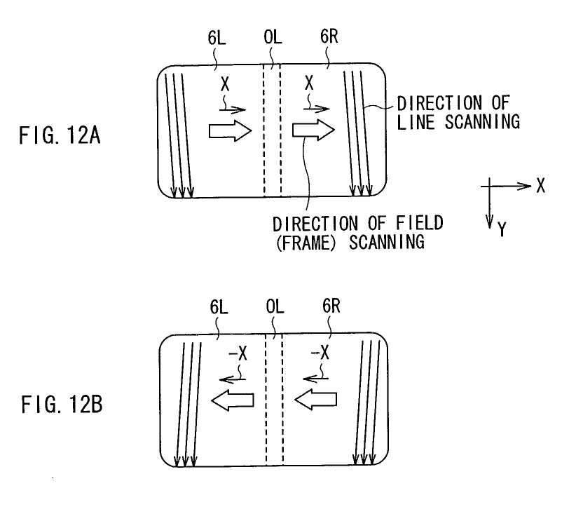

In the embodiment, a problem in scanning modes shown in FIGS. 12A and 12B is overcome. In the scanning mode shown in FIG. 12A, line scanning is carried out by the electron beams 5L and 5R in a direction from the top of the screen to the bottom thereof (in Y direction in the drawing). On the other hand, field (or frame) scanning is carried out on the split screens 6L and 6R on the left and the right sides in a direction from left to right (in X direction) viewed from the image-display surface. On the contrary, in the scanning mode shown in FIG. 12B, field scanning is carried out on the split screens 6L and 6R on the left and the right sides in a direction from right to left (in -X direction) viewed from the image-display surface.

Thus, the embodiment is applied to the scanning modes that the directions of field (or frame) scanning on the split screens 6L and 6R are in the same direction as each other. Further, line scanning may be carried out in a direction from the bottom of the screen to the top thereof (in -Y direction).

A problem in the scanning modes shown in FIGS. 12A and 12B is that when a moving image going across the overlap region OL is displayed, it is observed that the image is expanded or contracted. It results from a large difference in time when the overlap region OL is scanned by the electron beams on the left and the right sides. In the embodiment, according to a difference in time when the overlap region OL is scanned by the electron beams on the left and the right sides, the content of either of the images on the left and the right sides is shifted on a time-axis, so a phenomenon that the image is expanded or contracted can be avoided. The embodiment is significantly distinct from the first embodiment by the fact that the content of either of the images, instead of either of scanning time on the left and the right sides, is shifted on the time-axis. At this time, the amount of a shift of the image is set at a shorter period than a period of 1 field (or frame), which is described later. In order to shift the image on the time-axis by a shorter period than a period of 1 field (or frame), it is necessary to generate a new image which is not included in the original image (an interpolated image) from the original image by image interpolation processing.

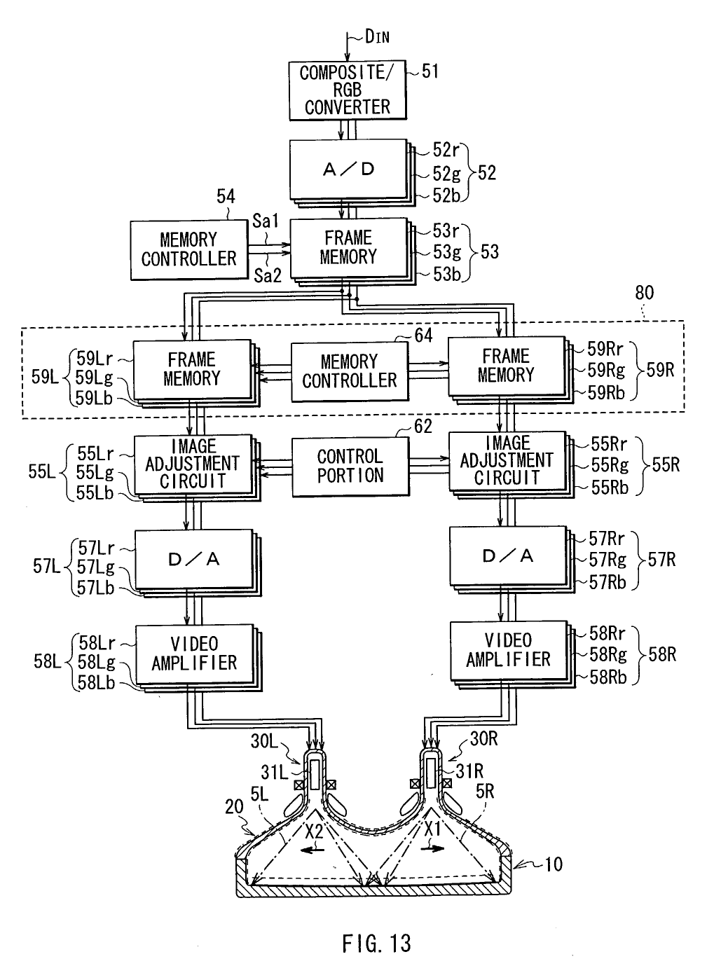

In order to generate the interpolated image, as shown in FIG. 13, the CRT according to the embodiment comprises an image interpolation circuit 80 in signal paths between the frame memory 53 and the image adjustment circuits 55L and 55R. The image interpolation circuit 80 generates an interpolated image for either of the split screens 6L and 6R and replaces the interpolated image with the original image data. The image interpolation circuit 80 includes frame memories 59L (59Lr, 59Lg and 59Lb) and 59R (59Rr, 59Rg and 59Rb) and a memory controller 64.

The frame memories 59L and 59R have a function of storing a plurality of frames of image signals (digital image data) of the split screen 6L and 6R on the left and the right sides, respectively, dividedly outputted from the frame memory 53 by color of R, G and B.

The memory controller 64 has a function of controlling a write operation and a read operation of image data for the frame memories 59L and 59R. The memory controller 64 generates an interpolated image data for either of the split screens 6L and 6R based on the image data stored in the frame memories 59L and 59R.

The configurations of the frame memories 59L and 59R in the case where an interpolated image for the split screen 6R on the right side is generated are described below. In this case, the frame memory 59R on the right side includes three frame memories 81R, 82R and 83R, for example, as shown in 14A. The first frame memory 81R and the second frame memory 82R successively store temporally continuous image data in frame. The third frame memory 83R stores an interpolated image data generated based on the image data stored in the first frame memory 81R and the second frame memory 82R.

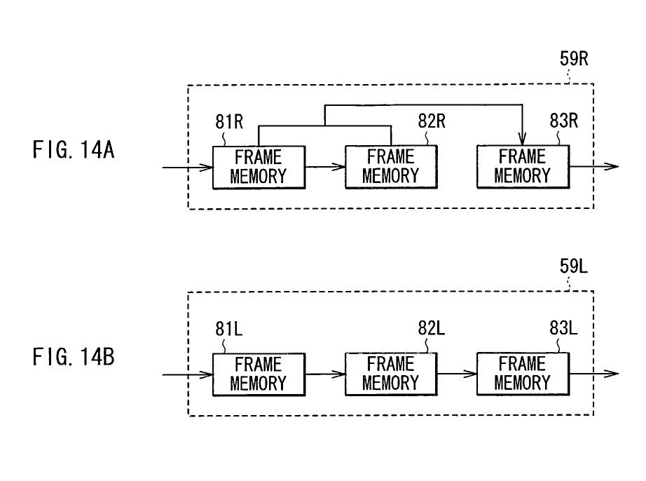

Further, in this case, the frame memory 59L on the left side, as shown in FIG. 14B, includes three frame memories 81L, 82L and 83L which are successively connected in series. The frame memories 81L, 82L and 83L successively store temporally continuous image data in frame. The frame memories 81L, 82L and 83L are provided to put the image data for the split screen 6L on the left side on standby while the memory controller 64 is generating an interpolated image. In other words, the frame memories 81L, 82L and 83L are provided to delay outputting the image data for the split screen 6L on the left side corresponding to a period when the interpolated image is generated.

Moreover, in order to generate an interpolated image for the split screen 6L on the left side, the frame memory 59L on the left side may have the configuration shown in FIG. 14A, and the frame memory 59R on the right side may have the configuration shown in FIG. 14B.

Incidentally, in the embodiment, the frame memory 59R(or 59L) corresponds to a specific example of “a memory means” in the invention, and the memory controller 64 corresponds to a specific example of “a generation means” in the invention. Further, in the circuits shown in FIG. 13, a circuit portion including at least the image interpolation circuit 80 corresponds to a specific example of “a scanning control device” in the invention.

Next, operations of the CRT according to the embodiment, specifically operations of the image interpolation circuit 80 are described in detail below.

The image data for the split screens 6L and 6R on the left and the right sides dividedly outputted from the frame memory 53 are inputted into the frame memories 59L and 59R of the image interpolation circuit 80, respectively. The frame memories 59L and 59R store a plurality of frames of image data on the left and the right sides. The memory controller 64 generates an interpolated image for either of the split screens 6L and 6R based on the image data stored in the frame memories 59L and 59R. The interpolated image generated by the memory controller 64 depends on the scanning mode. The memory controller 64 generates the interpolated image for either of the split screens 6L and 6R in which the overlap region OL is scanned earlier. In other words, in the scanning mode shown in FIG. 12A, an interpolated image for the split screen 6R on the right side is generated, and in the scanning mode shown in FIG. 12B, an interpolated image for the split screen 6L on the left side is generated.

For example, when generating the interpolated -image for the split screen 6R on the right side, the memory controller 64, as shown in FIG. 14A, generates image data at a predetermined time between two temporally adjacent frames (or fields) as an interpolated image in the third frame memory 83R based on two frames of image data stored in the first frame memory 81R and the second frame memory 82R in the frame memory 59R on the right side. The generated interpolated image is outputted in place of the original image signal. On the other hand, in the frame memory 59L on the left side, as shown in FIG. 14B, the image date for the split screen 6L on the left side is successively inputted and outputted into and from the frame memories 81L, 82L and 83L which are disposed to be equal in number to frame memories in the frame memory 59R, and the time of signal output is delayed by a period corresponding to a period when the memory controller 64 generates the interpolated image. When generating an interpolated image for the split screen 6L on the left side, processing opposite to the above is carried out.

For example, the concept of motion compensation used in MPEG can be used for generating the interpolated image.

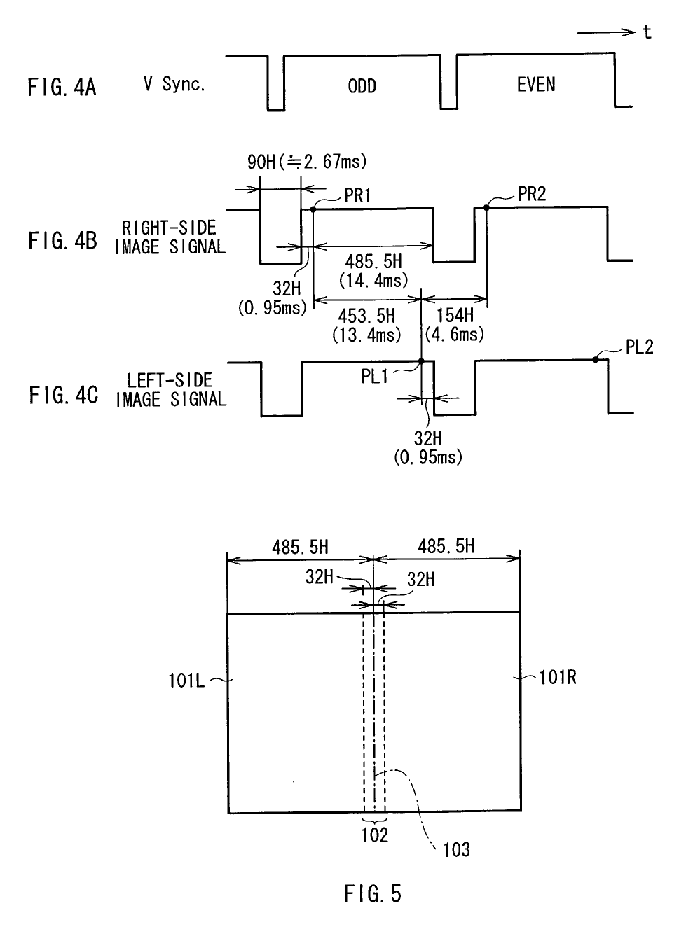

The image signals on the left and the right sides outputted from the image interpolation circuit 80 through the above processing are relatively shifted on the time-axis. In the other words, the interpolated image is an image relatively delayed in time behind the other image. Further, the actual time at which the interpolated image is generated between the frames (fields) (that is, an amount of the shift between the images on the left and the right sides) depends on conditions such as a signal format and the width of the overlap region OL. In an experiment, in the scanning mode shown in FIG. 12A, it was confirmed that between a case where there was no time shift between the images on the left and the right sides and a case where the image on the right side was delayed behind the image on the left side by 1 field, the relation of expansion and contraction of the image which occurred when the image was panned was reversed. Accordingly, it is known that there is a point where an image which does not look strange (that is, an inconspicuously expanded or contracted image) can be generated between the image not delayed and the image delayed in time by 1 field. It seems preferable that the amount of the shift in time between the images on the left and the right sides is determined, for example, corresponding to a difference in time when the overlap region OL is scanned (refer to FIG. 4) in consideration of the time of scanning the screens on the left and the right sides. More specifically, a time (amount of the shift) ta of an interpolated image from a image as a reference (which is an image not interpolated) is preferably within a range of the order of “0<ta≦Tf/2”. Tf indicates a period of 1 frame (or field).

After predetermined signal processing is performed on the image signals on the left and the right sides outputted from the image interpolation circuit 80 in the image adjustment circuits 55L and 55R, the image signals are converted into analog signals in the D/A converters 57L and 57R. The video amplifiers 58L and 58R amplify the image signals on the left and the right sides converted into the analog signals by color, and apply the amplified image signals as cathode drive voltages to cathodes corresponding to the electron guns 31L and 31R. Each of the electron guns 31L and 31R emits the electron beams 5L and 5R of each color according to the cathode drive voltages applied so as to correspond to each of the image signals. The split screens 6L and 6R are scanned by the electron beams 5L and 5R so as to display a desired image on the tube surface 11B.

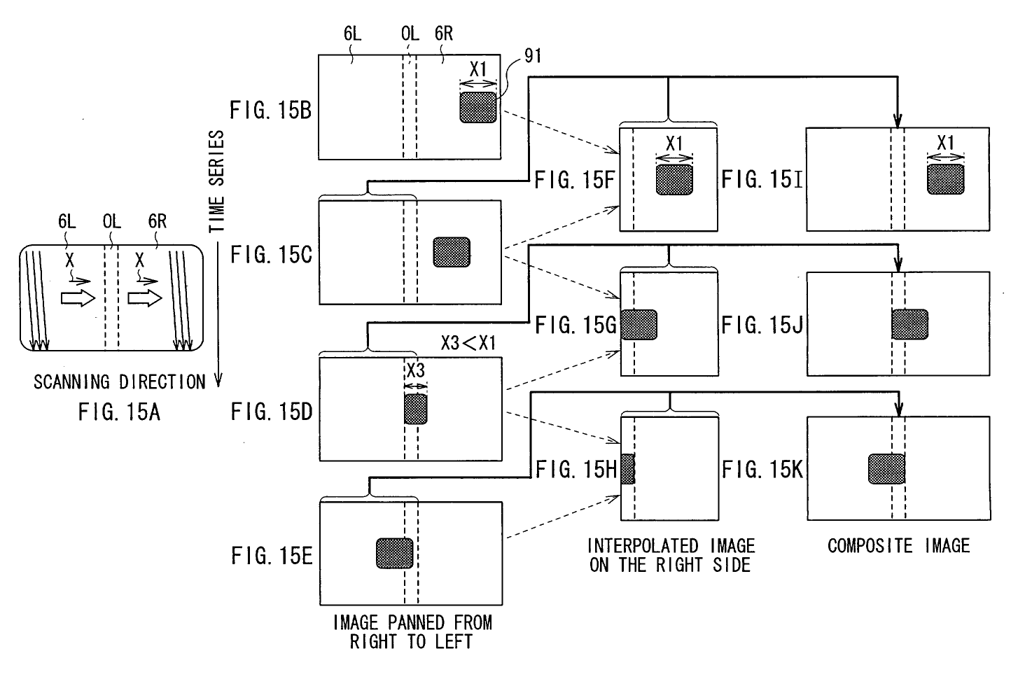

Next, referring to FIGS. 15A through 15K, a specific example of a state of an image displayed in the case where image processing by the image interpolation circuit 80 is carried out is described below.

In this case, as shown in FIG. 15A, field (or frame) scanning is carried out in a direction from left to right viewed from the image-display surface. Also, in this case, an image 91 having a rectangular shape with a width X1 is moved (panned) from right to left on the screen to be displayed. Each of FIGS. 15B through 15K shows an image in frame (or field). When screen scanning is carried out based on the original signal without image interpolation processing by the image interpolation circuit 80, on the screen, as shown in FIGS. 15B through 15E, the image is observed in a state that the image is contracted to a width X3 (<X1) when the image goes across the overlap region OL (refer to FIG. 15D).

On the other hand, when screen scanning is carried out based on the image signal after the interpolation processing by the image interpolation circuit 80 is carried out, as shown in FIGS. 151 through 15K, a proper image which is corrected on the image contraction is displayed. The composite images shown in FIGS. 15I through 15K are combinations of the original images shown in FIGS. 15B through 15E on the left side and the interpolated images shown in FIGS. 15F through 15H on the right side. In this case, the interpolated image shown in FIG. 15F is generated based on the images on the right side shown in FIGS. 15B and 15C. The interpolated image shown in FIG. 15G is generated based on the images on the right side in the FIGS. 15C and 15D. The interpolated image in FIG. 15H is generated based on the images shown in FIGS. 15D and 15E on the right side.

As described above, according to the embodiment, image interpolation processing is carried out to generate and output a new image signal delayed behind the image signal for either of split screens 6L and 6R by a predetermined period as the image signal for the other split screen, and the image signals in a state that the content of the image is temporally shifted between the split screens 6L and 6R are applied to the electron guns 31L and 31R. Therefore, in the scanning mode that the direction of field (or frame) scanning on the split screens 6L and 6R is the same direction as each other, expansion or contraction of the image resulting from a difference in time when the split screens 6L and 6R are scanned can be avoided. Thereby, in the scanning mode shown in FIGS. 12A and 12B, a proper image can be displayed.

The invention is not limited to the above embodiments and is applicable to various modifications. For example, in the above embodiments, the analog composite signal is used as the image signal D_{IN}, but the image signal D_{IN} is not limited to this. For example, an RGB analog signal may be used as the image signal D_{IN}. In this case, the RGB signal can be obtained without using the composite/RGB converter 51 (refer to FIGS. 8 and 13). Moreover, a digital signal used in a digital television or the like may be inputted as the image signal D_{IN}. In this case, the digital signal can be directly obtained without using the A/D converter 52 (refer to FIGS. 8 and 13).

Moreover, the invention is applicable to a CRT comprising three or more electron guns so as to form one screen with a combination of three or over scanning screens. Further, in the above embodiments, the CRT for color display is described, although the invention is applicable to a CRT for monochrome display.

As described above, according to the CRT, the scanning control device or the scanning method of a first aspect of the invention, a relative difference in scanning time of electron beams which scans a plurality of screen regions is generated so as to carry out screen scanning so that the sum of beam currents applied to a phosphor in the same pixel position per unit time does not exceed the limit of intensity saturation of the phosphor. Therefore, an intensity drop resulting from the intensity saturation of the phosphor in a scanning mode that field scanning or frame scanning is carried out on adjacent screen regions in a direction opposite to each other can be avoided. Thereby, in the scanning mode, a proper image can be displayed.

According to the CRT, the scanning control device or the scanning method of a second aspect of the invention, a plurality of frames of image data for one of two adjacent screen regions is stored, and image interpolation processing is carried out based on the stored image data, so as to generate a new image signal delayed behind the image signal for the other screen region by a predetermined period. The generated image signal is outputted as an image signal for the one of the screen regions. The image signal in a state that the content of the image is temporally shifted between the two adjacent screen regions is applied to the electron guns, therefore, in a scanning mode that field scanning or frame scanning is carried out on the adjacent screen regions in the same direction as each other, expansion or contraction of the image resulting from a difference in scanning time between the adjacent screen regions can be avoided. Thereby, a proper image can be displayed in the scanning mode.

Obviously many modifications and variations of the present invention are possible in the light of the above teachings. It is therefore to be understood that within the scope of the appended claims the invention may be practiced otherwise than as specifically described.

What is claimed is:

1. A cathode ray tube wherein
a single screen is split into a plurality of screen regions, and the plurality of screen regions overlap one another on a phosphor screen to combine together, and field scanning or frame scanning is carried out on adjacent screen regions in a direction opposite to each other, so that an image is displayed,
the cathode ray tube comprising:
a plurality of electron guns emitting a plurality of electron beams for scanning the plurality of screen regions to the phosphor screen; and
a frame synchronizer generating a relative difference in scanning time of the plurality of electron beams scanning the plurality of screen regions so that the sum of beam currents applied to a phosphor in the same pixel position per unit time does not exceed a limit of intensity saturation of the phosphor in a region where the plurality of screen regions overlap one another.

2. A cathode ray tube according to claim 1, wherein
the frame synchronizer includes:
a first memory means storing a first image signal for scanning a first screen region among the plurality of screen region;
a second memory means storing a second image signal for scanning a second screen region adjacent to the first screen region; and
a memory controller controlling the first memory means and the second memory means so as to relatively delay outputting either of the first and the second image signals from the first and the second memory means with respect to the other image signal.

3. A cathode ray tube according to claim 2, wherein
the memory controller delays outputting the image signal by at least a signal period corresponding to a period when a region where the sum of beam currents applied to the phosphor in the same pixel position exceeds the limit of intensity saturation of the phosphor is scanned.

4. A cathode ray tube wherein
a single screen is split into a plurality of screen regions, and the plurality of screen regions overlap one another on a phosphor screen to combine together, and field scanning or frame scanning is carried out on adjacent screen regions in the same direction as each other, so that an image is displayed,
the cathode ray tube comprising:
a plurality of electron guns emitting a plurality of electron beams for scanning the plurality of screen regions based on a plurality of image signals applied;
a memory means storing a plurality of frames of image data for one of two adjacent screen regions; and
a generation means carrying out image interpolation processing based on the image data stored in the memory means so as to apply an image signal in a state that the content of a image is temporally shifted between two adjacent screen regions to the electron guns, and thereby generating a new image signal delayed behind an image signal for the other screen region only by a predetermined period and outputting the generated image signal as the image signal for the one of the screen regions.

5. A cathode ray tube according to claim 4 wherein
the generation means is configured so as to generate an interpolated image at a predetermined time between temporally adjacent fields or frames by image interpolation processing.

6. A scanning control device controlling scanning of an electron beam in a cathode ray tube, wherein
the cathode ray tube comprises:
a plurality of electron guns emitting a plurality of electron beams to a phosphor screen,
wherein a single screen is split into a plurality of screen regions, and the plurality of screen regions overlap one another on the phosphor screen to combine together, and field scanning or frame scanning is carried out on adjacent screen regions in a direction opposite to each other, so that an image is displayed,
the scanning control device comprises:
a frame synchronizer generating a relative difference in scanning time of the plurality of electron beams scanning the plurality of screen regions so that the sum of beam currents applied to a phosphor in the same pixel position per unit time does not exceed a limit of intensity saturation of the phosphor in a region where the plurality of screen regions overlap one another.

7. A scanning control device controlling scanning of an image in a cathode ray tube, wherein
the cathode ray tube comprises:
a plurality of electron guns emitting a plurality of electron beams based on a plurality of image signals applied,
wherein a single screen is split into a plurality of screen regions, and the plurality of screen regions overlap one another on a phosphor screen to combine together, and field scanning or frame scanning is carried out on adjacent screen regions in the same direction as each other, so that an image is displayed,
the scanning control device comprises:
a memory means storing a plurality of frames of image data for one of two adjacent screen regions; and
a generation means carrying out image interpolation processing based on the image data stored in the memory means so as to apply an image signal in a state that the content of a image is temporally shifted between the two adjacent screen regions to the electron guns, and thereby generating a new image signal delayed behind an image signal for the other screen region only by a predetermined period and outputting the generated image signal as the image signal for the one of the screen regions.

8. A scanning method for controlling scanning of an electron beam in a cathode ray tube, wherein
the cathode ray tube comprises:
a plurality of electron guns emitting a plurality of electron beams to a phosphor screen,
wherein a single screen is split into a plurality of screen regions, and the plurality of screen regions overlap one another on the phosphor screen to combine together, and field scanning or frame scanning is carried out on adjacent screen regions in a direction opposite to each other, so that an image is displayed,
the scanning method comprises the step of:
generating a relative difference in scanning time of the plurality of electron beams scanning the plurality of screen regions so that the sum of beam currents applied to a phosphor in the same pixel position per unit time does not exceed a limit of intensity saturation of the phosphor in a region where the plurality of screen regions overlap one another to carry out screen scanning.

9. A scanning method for controlling scanning of an image in a cathode ray tube, wherein
the cathode ray tube comprises:
a plurality of electron guns emitting a plurality of electron beams based on a plurality of image signals applied,
wherein a single screen is split into a plurality of screen regions, and the plurality of screen regions overlap one another on a phosphor screen to combine together, and field scanning or frame scanning is carried out on adjacent screen regions in the same direction as each other, so that an image is displayed,
the scanning method comprises the steps of:
storing a plurality of frames of image data for one of two adjacent screen regions;
carrying out image interpolation processing based on the stored image data, and thereby generating a new image signal delayed behind an image signal for the other screen region only by a predetermined period and outputting the generated image signal as the image signal for the one of the screen regions; and
applying an image signal in a state that the content of an image is temporally shifted between the two adjacent screen regions to the electron guns.
